(19) United States
(12) Patent Application Publication
(10) Pub. No.: US 2019/0068701 A1
(43) Pub. Date: Feb. 28, 2019

(54) Content Scheduling Method Based on CDN and P2P Network, and Communication Network

(71) Applicant: BOE TECHNOLOGY GROUP CO., LTD., Beijing (CN)

(72) Inventor: Litong HAN, Beijing (CN)

(21) Appl. No.: 15/983,465

(22) Filed: May 18, 2018

(30) Foreign Application Priority Data
Aug. 31, 2017 (CN) 201710772833.3

(51) Int. Cl. H04L 29/08; H04L 12/911

(52) U.S. Cl. CPC H04L 67/1074; H04L 47/822; H04L 67/32

(57) ABSTRACT

Disclosed is a content scheduling method based on content delivery network (CDN) and peer-to-peer (P2P) network, including steps of: acquiring, by a content list server, a data request sent from a first super node; determining, by the content list server, a target edge server corresponding to the target data by querying a first content list; and directing the data request to the target edge server, such that the target edge server sends the target data to the first node.

### CROSS-REFERENCE TO RELATED APPLICATION

This application claims priority to Chinese Patent Application No. 201710772833.3, filed on Aug. 31, 2017, the entire contents of which are hereby incorporated by reference.

### TECHNICAL FIELD

The present disclosure relates to a content scheduling method based on CDN and P2P network, and a communication network.

### BACKGROUND

The Content Delivery Network (CDN) technology is a method for distributing content from a source server to an edge server close to the user, so as to achieve distributed and nearby access to the content. Peer-to-Peer (P2P) is a method for delivering large-scale content through direct content exchange between user clients.

### SUMMARY

An overview of the detailed description of the subject matters described in the present disclosure is as follows. The overview is not intended to limit the protection scope of the claims.

In one aspect, the present disclosure provides a content scheduling method based on content delivery network (CDN) and peer-to-peer (P2P) network, including steps of: acquiring, by a content list server, a data request sent from a first super node, the data request carrying an identification of target data and an identification of a first node requesting the target data; determining, by the content list server, a target edge server corresponding to the target data by querying a first content list stored in the content list server, the first content list including a mapping relationship between edge servers and contents; and directing the data request to the target edge server, such that the target edge server sends the target data to the first node.

In some embodiments, the content list server further stores a second content list including a mapping relationship between super nodes and contents; and after the step of acquiring the data request sent from the first super node, the content list server may further determine a target super node corresponding to the target data by querying the second content list.

In some embodiments, before the step of directing the data request to the target edge server, the method further includes a step of determining whether current time delay and bandwidth of the target edge server are superior to current time delay and bandwidth of the target super node. In response to the current time delay and bandwidth of the target edge server being superior to the current time delay and bandwidth of the target super node, the data request is directed to the target edge server, such that the target edge server sends the target data to the first node. In response to the current time delay and bandwidth of the target edge server not being superior to the current time delay and bandwidth of the target super node, the data request is directed to the target super node, such that the target super node sends the target data to the first node.

In some embodiments, the method further includes a step of sending, by the content list server at a selected time interval, a first content list acquisition request to the edge server.

In some embodiments, the method further includes a step of updating, by the content list server, the first content list based on a data update message acquired from a back-to-source-authentication server.

In some embodiments, the step of directing the data request to the target edge server includes sending the data request and an identification of the target edge server to a redirect server, such that the data request is sent from the redirect server to the target edge server.

In some embodiments, the method further includes a step of updating, by the content list server, content in the second content list corresponding to the first super node based on the identification of the target data.

In some embodiments, the content list server further includes a third content list including a mapping relationship between warm-up edge servers and contents; and after the step of acquiring the data request sent from the first super node, the method further includes steps of: determining whether the identification of the target data satisfies a selected criterion; and in response to the identification of the target data satisfying the selected criterion, querying the third content list by the content list server to determine a warm-up edge server corresponding to the identification of the target data.

In another aspect, the present disclosure provides a content scheduling method based on content delivery network (CDN) and peer-to-peer (P2P) network, including steps of: acquiring, by a first super node, a data request sent from a first node, the data request carrying an identification of target data; sending, by the first super node, the data request to a content list server, when it is determined that a network to which the first super node belongs does not include the target data; and receiving the target data returned from a target edge server, the target edge server being determined by the content list server based on the identification of the target data and a first content list, the first content list including a mapping relationship between edge servers and contents.

In some embodiments, the method includes a step of receiving the target data returned from a second super node, the second super node being determined by the content list server after the content list server determines that current time delay and bandwidth of the second super node are superior to current time delay and bandwidth of the target edge server.

In some embodiments, the method includes a step of updating a content list corresponding to the first node after the first super node determines that the first node has acquired the target data.

In yet another aspect, the present disclosure provides a communication network, including a content list server and a super node, the content list server being configured to perform the content scheduling method according to said one aspect, and the super node being configured to perform the content scheduling method according to said another aspect.

In yet another aspect, the present disclosure provides a computing device including a memory and one or more processors coupled with the memory, the memory stores computer executable instructions, which when executed, cause the one or more processors to perform one or more steps of the method according to said one aspect.

In yet another aspect, the present disclosure provides a computing device including a memory and one or more processors coupled with the memory, the memory stores computer executable instructions, which when executed, cause the one or snore processors to perform one or more steps of the method according to said another aspect.

### BRIEF DESCRIPTION OF THE DRAWINGS

The above and/or additional aspects and advantages of the present disclosure will become apparent and easily understood from the following description of embodiments in conjunction with the accompanying drawings, in which:

FIG. 1 is a schematic flowchart illustrating a content scheduling method based on CDN and P2P network according to some embodiments of the present disclosure;

FIG. 2 is another schematic flowchart illustrating a content scheduling method based on CDN and P2P network according to some embodiments of the present disclosure;

FIG. 3 is yet another schematic flowchart illustrating a content scheduling method based on CDN and P2P network according to some embodiments of the present disclosure;

FIG. 4 is a diagram illustrating signaling interaction in a content scheduling method based on CDN and P2P network according to some embodiments of the present disclosure;

FIG. 5 is another diagram illustrating signaling interaction a content scheduling method based on CDN and P2P network according to some embodiments of the present disclosure;

FIG. 6 is a schematic diagram illustrating a structure of a communication network according to some embodiments of the present disclosure; and

FIG. 7 is a schematic diagram illustrating another structure of a communication network according to some embodiments of the present disclosure.

### DETAILED DESCRIPTION

Embodiments of the present disclosure are described in detail below, examples of which are illustrated in the accompanying drawings, in which the same or similar reference numerals denote the same or similar elements or dements having the same or similar functions throughout. The embodiments described below with reference to the accompanying drawings are exemplary and are intended to explain the present disclosure, but should not be construed as limiting the present disclosure.

The Content Delivery Network (CDN) technology is a method of distributing content from a source server to an edge server close to the user, so as to achieve distributed and nearby access to the content. Peer-to-Peer (P2P) is a method for delivering large-scale content through direct content exchange between user clients.

However, there are certain problems when a content bearer network is constructed based on only CDN or only P2P network. When the network is constructed based on CDN alone, services still depend on servers, thereby causing high cost in providing large-scale services and poor scalability. When the network is constructed based on P2P alone, the availability and performance of system services are difficult to guarantee, and the system has a higher demand for user scale.

In technologies known by the inventor of the present disclosure, CDN and P2P may be converged to solve the problems which are difficult to be solved when the network is constructed based on CDN or P2P alone. However, in a converged network of CDN and P2P, when a client acquires data from a source server, the user's preferences vary from client to client, and it is difficult for the CDN to cache personalized data accessed by a large number of users, and the forced use of CDN may result in a large amount of backtracking requests, thereby increasing the burden on the network, making the acquisition process of the personalized data complicated and time-consuming.

Embodiments of the present disclosure provides a content scheduling method based on CDN and P2P network to at least partially address the following problems in the converged network of CDN and P2P: when a client acquires data from a source server, the user's preferences vary from client to client, and it is difficult for the CDN to cache personalized data accessed by a large number of users, and the forced use of CDN may result in a large amount of backtracking requests, thereby increasing the burden on the network, making the acquisition process of the personalized data complicated and time-consuming.

In the content scheduling method based on CDN and P2P network according to the embodiments of the present disclosure, a content list server may be provided in a network, and the content list server is configured to store a mapping relationship between all edge servers and their stored contents, such that when a node requests target data through a first super node, the target data can be quickly acquired, based on the mapping relationship, from an edge server corresponding to the target data, thereby reducing the burden on the network, simplifying the process of obtaining the personalized data, saving the acquisition time of the personalized data, and improving the user experience.

In the following embodiments, the concept of a content list is used, which describes the correspondence between the identification of data and the storage location of data in the network. For example, a digital digest (Hash: MD5, SHA, CRC, etc.) of a file can be formed from the file content itself as its distinguishable unique identification, and a corresponding relationship can be generated between the unique identification and the absolute or relative storage location of the file.

In the following embodiments, concepts such as an edge server and a source server are used to describe the different types of servers in the CDN network structure and are understood by those skilled in the art; concepts such as nodes and super nodes are used to describe the different types of terminals in the P2P network and are understood by those skilled in the art.

It should be noted that the so-called edge server, source server, etc. and nodes, super nodes, etc. are selected in the corresponding network structure based on their use, function design, etc., and do not represent physical differences.

A content scheduling method based on CDN and P2P network and a communication network according to embodiments of the present disclosure will be described below with reference to the accompanying drawings.

First, a content scheduling method based on CDN and P2P network according to embodiments of the present disclosure will be explained from a content list serverside by way of example.

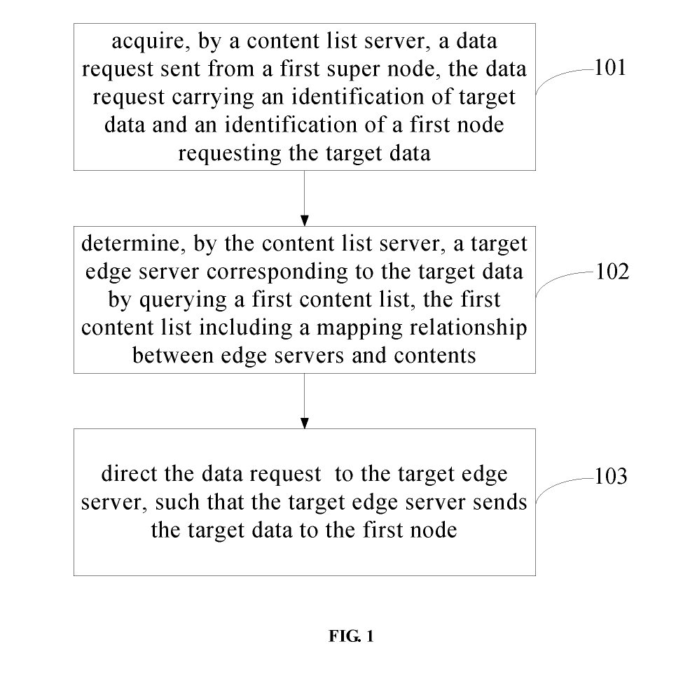

FIG. 1 is a schematic flowchart illustrating a content scheduling method based on CDN and P2P network according to some embodiments of the present disclosure.

As shown in FIG. 1, the content scheduling method based on CDN and P2P network includes the following steps of 101 to 103.

At step 101, a content list server acquires a data request sent from a first super node, the data request carrying an identification of target data and an identification of a first node requesting the target data.

For example, the content scheduling method based on CDN and P2P network according to the embodiments of the present disclosure may be performed by the content list server.

For example, the first node may send the data request to the first super node, such that the first super node may send the data request to the content list server after acquiring the data request.

Here, the identification of the target data is configured to uniquely identify the target data, and the identification of the first node is configured to uniquely identify the first node.

At step 102, the content list server determines a target edge server corresponding to the target data by querying a first content list, the first content list including a mapping relationship between edge servers and contents.

For example, a mapping relationship between all edge servers and their stored contents may be stored in the first content list of the content list server, such that when the content list server has acquired the data request sent from the first super node, it can determine the target edge server corresponding to the target data in the data request by querying the mapping relationship in the first content list based on the identification of the target data in the data request.

For example, it is assumed that a mapping relationship between edge servers and their stored contents stored in the first content list is as follows: picture “a” being stored in an edge server A, file “b” being stored in an edge server B, audio “c” being stored in an edge server C, and the like. In this case, when the identification of the target data in the data request acquired by the content list server is “a”, the edge server A can be determined as the target edge server corresponding to the target data by querying the first content list.

It should be noted that in practice, the target data may be stored in each of a plurality of edge servers, i.e., the target data may correspond to the plurality of edge servers. In some embodiments, any one of the plurality of edge servers corresponding to the target data may be determined as the target edge server. In some embodiments, the edge server having optimal current time delay and bandwidth among the plurality of edge servers may be determined as the target edge server. For example, which one of the edge servers is best suitable for sending the target data may be evaluated based on at least one of time delay and bandwidth, and the edge server having optimal current time delay and/or bandwidth may be determined as the target edge server based on the evaluation result. In some embodiments, priority of time delay may be set to be higher than priority of bandwidth.

At step 103, the data request is directed to the target edge server, such that the target edge server sends the target data to the first node.

In some embodiments, the content list server may have a redirect function, such that the content list server may direct the data request to the target edge server corresponding to the target data when the content list server has determined the target edge server by querying the first content list, thereby causing the target edge server to send the target data to the first node based on the identification of the first node and the identification of the target data in the data request.

In some embodiments, a separate redirect server may be provided, and the content list server may send the data request and an identification of the target edge server corresponding to the data request to the redirect server when the content list server has determined the target edge server by querying the first content list, thereby causing the redirect server to send the data request to the target edge server, which in turn send the target data to the first node. In some embodiments, the step 103 of directing the data request to the target edge server may includes sending the data request and the identification of the target edge server to a redirect server, such that the data request is sent from the redirect server to the target edge server.

By separately providing the redirect server and the content list server, it is possible to easily maintain the content list server, thereby improving reliability.

It can he understood that the first content list of the content list server stores therein a mapping relationship between all edge servers and their stored contents, while data stored in the edge servers may be updated in a real-time manner or at preset time interval. Therefore, in order to ensure that data in the first content list of the content list server matches data stored in the edge servers, the first content list needs to be updated according to the embodiments of the present disclosure.

The first content list of the content list server may be updated in various ways.

In some embodiments, the content list server sends a first content list acquisition request to the edge server at a selected time interval. The time interval may be set as required.

For example, the content list server may send the first content list acquisition to respective edge servers, such that the edge servers in each of which update of data occurs may send an identification corresponding to updated data to the content list server, such that the content list server may update the mapping relationship stored in the first content list.

In some embodiments, the content list server may update the first content list based on a data update message acquired from a back-to-source-authentication server.

For example, a back-to-source-authentication server may be provided. The back-to-source-authentication server may acquire Hash digest corresponding to content in a source server at a selected time interval. When data in the source server has been updated, the source server may send the Hash digest corresponding to the updated data to the back-to-source-authentication server, which may thereby send an update message to the edge server, such that the edge server may update its stored content. Meanwhile, the back-to-source-authentication server may send a data update message to the content list server, the data update message including an identification of the edge server in which update of data occurs, such that the content list server may update the first content list based on the data update message.

For example, when the content list server has acquired the data update message including the identification of the edge server, it may send a first content list acquisition request to the edge server corresponding to the identification of the edge server, such that the corresponding edge server sends an identification corresponding to the updated data to the content list server, and the content list server may update the mapping relationship stored in the first content list.

It should be noted that the back-to-source-authentication server may he implemented by one or more edge servers, which is not limited herein.

By updating the first content list, the accuracy and reliability of content scheduling can be improved.

In the content scheduling method based on CDN and P2P network according to the embodiments of the present disclosure, after the content list server acquires the data request sent from the first super node, it may determine the target edge server corresponding to the target data by querying the first content list, thereby directing the data request to the target edge server such that the target edge server sends the target data to the first node. Accordingly, by providing the content list server in the CDN and P2P network to store a mapping relationship between edge servers and their stored contents, when a node requests target data through the first super node, the target data can be quickly acquired, based on the mapping relationship, from an edge server corresponding to the target data, thereby reducing the burden on the network, simplifying the process of obtaining the personalized data, saving the acquisition time of the personalized data, and improving the user experience.

From above description it can be seen that the CDN and P2P network may be provided with a content list server configured to store a mapping relationship between edge servers and their stored contents, such that when a first node requests target data through the first super node, the target data can be quickly acquired based on the mapping relationship.

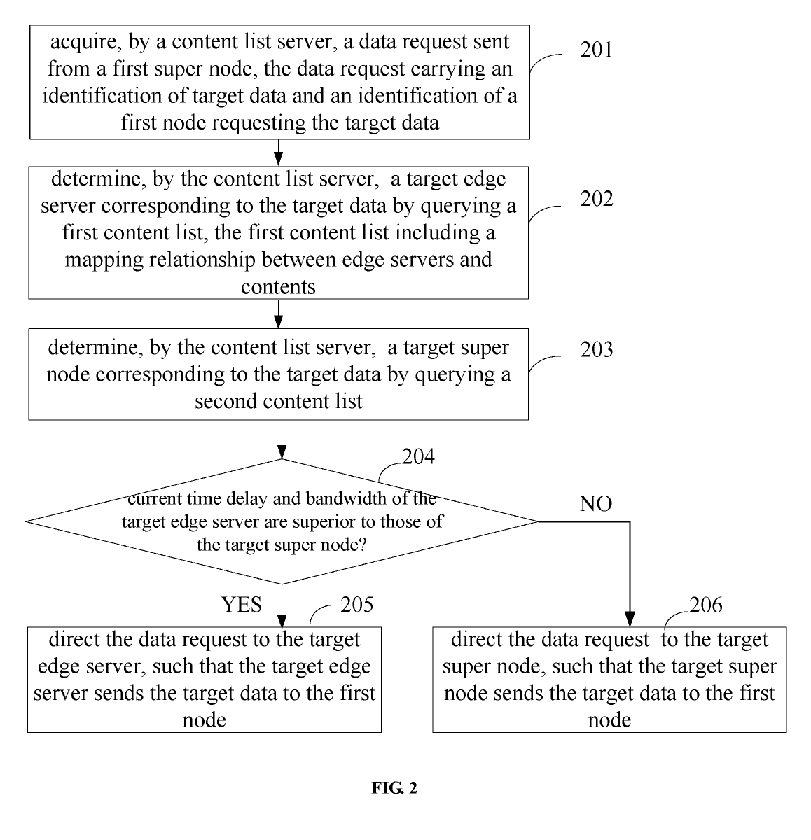

In some cases, networks to which other super nodes belong may have stored the target data. Next, the above cases will be described in detail with reference to FIG. 2.

FIG. 2 is another schematic flowchart illustrating a content scheduling method based on CDN and P2P network according to some embodiments of the present disclosure.

As shown in FIG. 2, the content scheduling method based on CDN and P2P network includes the following steps of 201 to 206.

At step 201, a content list server acquires a data request sent from a first super node, the data request carrying an identification of target data and an identification of a first node requesting the target data.

At step 202, the content list server determines a target edge server corresponding to the target data by querying a first content list, the first content list including a mapping relationship between edge servers and contents.

The specific implementation processes and principles of steps 201 to 202 may refer to specific descriptions of the above embodiments, and will not be repeated here.

At step 203, the content list server determines a target super node corresponding to the target data by querying a second content list.

Here, a super node may he constituted by any one or more nodes. A super node may store correspondences between all nodes and their stored contents in the network to which the super node belongs.

For example, the content list server may also store the second content list, the second content list including a mapping relationship between super nodes and contents. Therefore, when the content list server has acquired the data request sent from the first super node, it can determine a target super node corresponding to the target data by querying the second content list based on the identification of the target data.

For example, it is assumed that a mapping relationship between edge servers and their stored contents stored in the second content list is as follows: picture “a” being stored in a super node A, file “b” being stored in a super node B, audio “c” being stored in a super node C, and the like. In this case, when the identification of the target data in the data request acquired by the content list server is “a”, the super node A can be determined as the target super node corresponding to the target data by querying the second content list.

In some cases, the target data may be stored in each of a plurality of super nodes, i.e., the target data may correspond to the plurality of super nodes. In some embodiments, any one of the plurality of super nodes corresponding to the target data may be determined as the target super node. In some embodiments, the super node having optimal current time delay and bandwidth among the plurality of super node may be determined as the target super node. For example, which one of the super nodes is best suitable for sending the target data may be evaluated based on at least one of time delay and bandwidth, and the super node having optimal current time delay and/or bandwidth may be determined as the target super node based on the evaluation result. In some embodiments, priority of time delay may be set higher than priority of bandwidth.

It should be noted that step 202 and step 203 may be performed simultaneously, or step 203 may be performed first, and then step 202 is performed, which is not limited here.

At step 204, it is determined whether current time delay and bandwidth of the target edge server are superior to current time delay and bandwidth of the target super node.

At step 205, in response to the current time delay and bandwidth of the target edge server being superior to the current time delay and bandwidth of the target super node, the data request is directed to the target edge server, such that the target edge server sends the target data to the first node.

At step 206, in response to the current time delay and bandwidth of the target super node being superior to the current time delay and bandwidth of the target edge server, the data request is directed to the target super node, such that the target super node sends the target data to the first node.

For example, the content list server may compare the current time delay and bandwidth of the target edge server with those of the target super node after determining the target edge server and target super node corresponding to the target data. In a case where the content list server determines that the current time delay and bandwidth of the target edge server are superior to the current time delay and bandwidth of the target super node, the data request may be directed to the target edge server, such that the target edge server sends the target data to the first node. In a case where the content list server determines that the current time delay and bandwidth of the target super node are superior to the current time delay and bandwidth of the target edge server, the data request may be directed to the target super node, such that the target super node sends the target data to the first node. In some embodiments, the content list server may be configured to determine which one of the target edge server and the target super node is more suitable for sending the target data to the first node. In some embodiments, priority of time delay may be set to be higher than priority of bandwidth.

The specific implementation process and principle of directing the data request to the target edge server or the target super node may refer to specific descriptions of the above embodiments, and will not be repeated here.

By directing the data request to the target edge server or the target super node having better time delay and bandwidth, it is possible to further reduce time for data acquisition and improve efficiency for data acquisition.

It should be noted that contents stored in the first node will be changed after the first node acquires the target data, and correspondingly, the contents of the first node stored in the first super node should be updated accordingly. In order to ensure that data stored in the second content list matches data stored in the first super node, the second content list needs to be updated. Thus, in some embodiments of the present disclosure, the method further includes updating contents in the second content list corresponding to the first super node based on the identification of the target data.

By updating the second content list in the content list server based on the identification of the target data, the data stored in the second content list matches the data stored in respective super nodes, thereby improving the accuracy and reliability of content scheduling.

Further, it can be understood that a case where a large amount of clients wish to acquire certain data during a certain time period may occur. In order to reduce possibility of back-to-source access, in some embodiments, a warm-up edge server may be provided to store certain data, such that when a client request the certain data, it can be acquired from the warm-up server, thereby reducing time for data acquisition and improving user experience.

Accordingly, in some embodiments, the content list server may further include a third content list including a mapping relationship between warm-up edge servers and contents.

In some embodiments, after step 201, the method further includes determining whether the identification of the target data satisfies a selected criterion; if yes, the third content list is queried to determine a warm-up edge server corresponding to the identification of target data.

Here, the selected criterion is configured to represent criterion satisfied by the identification of the content stored in the warm-up edge server, and may be set as required.

Further, the content stored in the warm-up edge server may be updated at a selected time interval, as needed.

For example, respective warm-up edge servers may be set in advance to store contents such as URLs (Uniform Resource Locater), files, pictures, audios and the like, which have highest visits or numbers of being-requested during the last 24 hours according to data requests of all clients from different regions, and the mapping relationship between the respective warm-up servers and their stored contents may be stored in the third content list. Therefore, if an identification of target data is determined to satisfy a selected criterion after a data request is acquired, it is possible to determine a warm-up edge server corresponding to the identification of target data by querying the third content list. After that, the data request is direct to the warm-up edge server, such that the warm-up edge server sends the target data to the first node.

Further, respective warm-up edge servers may be set in advance to store contents such as URLs (Uniform Resource Locater), files, pictures, audios and the like, which have visits or numbers of being-requested exceeding a preset threshold during the last 24 hours according to data requests of all clients from different regions, and the mapping relationship between the respective warm-up servers and their stored contents may be stored in the third content list. Therefore, after a data request is acquired, it is possible to determine whether data corresponding to an identification of target data has visits or numbers of being-requested exceeding the preset threshold during the last 24 hours, and if yes, it is possible to determine a warm-up edge server corresponding to the identification of the target data by querying the third content list. After that, the data request is direct to the warm-up edge server, such that the warm-up edge server sends the target data to the first node.

By providing the content list server with storage of the mapping relationship between the warm-up servers and their stored contents, certain content requested by a client can be quickly acquired, thereby improving flexibility of the network, and further simplifying data acquisition process and reducing data acquisition time.

In the content scheduling method based on CDN and P2P network according to the embodiments of the present disclosure, after the content list server acquires the data request from the first super node, it determines the target edge server and target super node corresponding to the target data by querying the first content list and the second content list, respectively. In a case where current time delay and bandwidth of the target edge server are superior to current time delay and bandwidth of the target super node, the date request may be directed to the target edge server, such that the target edge server sends the target data to the first node. In a case where current time delay and bandwidth of the target super node are superior to current time delay and bandwidth of the target edge server, the data request is directed to the target super node, such that the target super node sends the target data to the first node. Accordingly, by providing the content list server in the CDN and P2P network to store mapping relationships between edge servers and super nodes and their stored contents, when a node requests target data through the first super node, the target data can be quickly acquired, based on the mapping relationships, from an edge server or a super node corresponding to the target data, thereby reducing the burden on the network, simplifying the process of obtaining the personalized data, saving the acquisition time of the personalized data, and improving the user experience.

Next, a content scheduling method based on CDN and P2P network according to embodiments of the present disclosure will be explained from a first super node side by way of example.

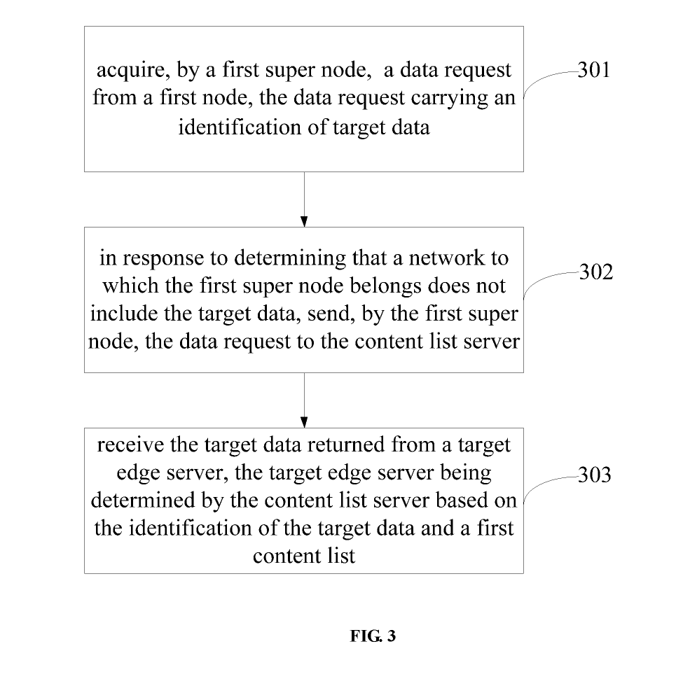

FIG. 3 is yet another schematic flowchart illustrating a content scheduling method based on CDN and P2P network according to some embodiments of the present disclosure.

As shown in FIG. 3, the content scheduling method based on CDN and P2P network includes the following steps of 301 to 303.

At step 301, a first super node acquires a data request from a first node, the data request carrying an identification of target data.

For example, the content scheduling method based on CDN and P2P network according to the embodiments of the present disclosure may be performed by the first super node.

For example, the first super node may be constituted by any one or more nodes. The first super node may store correspondence between all nodes and their stored contents in the network to which the first super node belongs.

It should be noted that the correspondence between contents and nodes in embodiments of the present disclosure refers to correspondence between identifications of data, such as pictures and URLs, and nodes.

At step 302, in response to determining that the network to which the first super node belongs does not include the target data, the first super node sends the data request to the content list server.

Here, the network to which the first super node belongs may refer to the first super node together with nodes in the network to which the first super node belongs.

For example, the first node may send the data request to the first super node, such that the first super node may determine whether the network to which the first super node belongs includes the target data after the first super node acquires the data request; and if no, the data request may be sent to the content list server.

It can be understood that if the network to which the first super node belongs includes the target data, the first super node may determine a target node corresponding to the identification of the target data based on the correspondence between all nodes and their stored contents, and direct the data request to the target node, such that the target node sends the target data to the first node.

At step 303, the target data returned from a target edge server is received, the target edge server being determined by the content list server based on the identification of the target data and a first content list.

For example, the first super node sends the data request to the content list server, and the content list server directs the data request to the target edge server, which in turn returns the target data to the first super node, such that the first super node returns the target data to the first node after it receives the target data.

It should be noted that the target edge server may also send the target data directly to the first node after it receives the data request, or may send the target data to the first node and the first super node simultaneously, which is not limited here.

In some embodiments, the target data requested by the first node through the first super node may be stored in a network to which another super node belongs, and in this case, after the first super node sends the data request to the content list server, in response to the content list server directing the data request to a second super node (i.e., a target super node), the second super node may return the target data to the first super node, which in turn sends the target data to the first node. That is to say, in some embodiments, the method may further includes receiving the target data returned from a second super node, the second super node being determined by the content list server after the content list server determines that current time delay and bandwidth of the second super node are superior to current time delay and bandwidth of the target edge server.

For example, after the second super node acquires the data request, it may determine a node corresponding to the target data by querying correspondence (stored in the second super node) between all nodes and their stored content in the network to which the second super node belongs based on the identification of the target data in the data request, and send the data request to the node corresponding to the target data. After the node corresponding to the target data acquires the data request, it may return the target data to the second super node, which in turn returns the target data to the first super node.

It should be noted that the second super node may also send the target data directly to the first node, or may send the target data to the first node and the first super node simultaneously, which is not limited here.

It should be noted that in the embodiments of the present disclosure, after the node corresponding to the target data acquires the data request, it may also return the target data directly to the node requesting the data.

Further, contents stored in the first node will be changed after the first node acquires the target data, and the contents of the first node stored in the first super node should be updated to match data stored in the first super node and data stored in the first node. That is, in some embodiments of the present disclosure, the method may further include updating content list corresponding to the first node when the first super node determines that the first node has acquired the target data.

For example, the target edge server or the second super node sends the target data to the first super node, which in turn sends the target data to the first node, or the target edge server or the second super node sends the target data to the first super node and the first node simultaneously. In these cases, the first super node may directly update its stored content list corresponding to the first node based on the target data sent from the target edge server or the second super node and the identification of the first node requesting the target data in the data request.

When the target edge server or the second super node sends the target data directly to the first node, the first node may send a data update message to the first super node after the first node acquires the target data, or the first super node may monitor data status in the first node to determine occurrence of change of data in the first node, such that the first super node may update its stored content list corresponding to the first node based on the identification of the target data in the data request.

In some embodiments, the second content list of the content list server stores a mapping relationship between all super nodes and their stored contents, and thus the second content list of the content list server also needs to be updated when data stored in the first super node has been updated.

For example, after occurrence of the change of data stored in the first super node, a data update message may be sent to the content list server, such that the content list server may update contents corresponding to the first super node in the second content list based on the identification of the target data.

In the content scheduling method based on CDN and P2P network according to the embodiments of the present disclosure, when the first super node has acquired the data request sent from the first node and determines that the network to which the first super node belongs does not include the target data, the data request may be sent to the content list server, so the first super node receives target data returned from the target edge server or the second super node. Accordingly, by providing the content list server in the CDN and P2P network to store a mapping relationship between edge servers and super nodes and their stored contents, when a node requests target data through the first super node, the target data can be quickly acquired, based on the mapping relationship, from an edge server or a super node corresponding to the target data, thereby reducing the burden on the network, simplifying the process of obtaining the personalized data, saving the acquisition time of the personalized data, and improving the user experience.

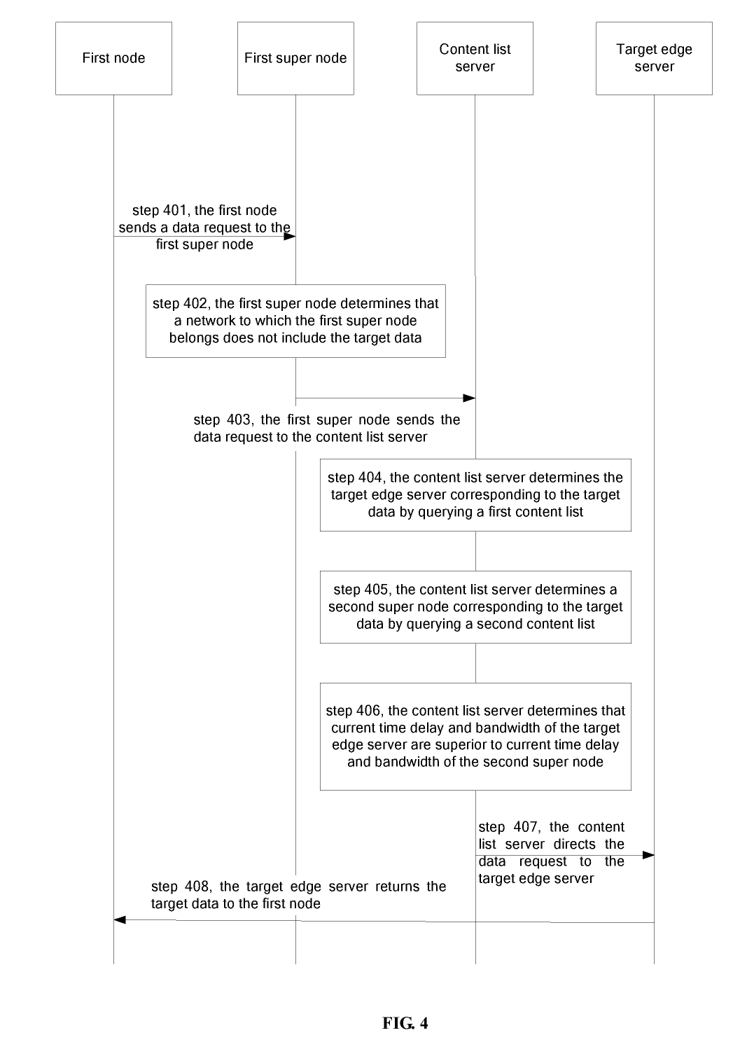

FIG. 4 is a diagram illustrating signaling interaction in a content scheduling method based on CDN and P2P network according to some embodiments of the present disclosure.

As shown in FIG. 4, the content scheduling method based on CDN and P2P network are implemented by a first node, a first super node, a content list server and a target edge server, and the signaling interaction includes the following steps of 401 to 408.

At step 401, the first node sends a data request to the first super node.

Here, the data request carries an identification of target data and an identification of the first node requesting the target data.

At step 402, the first super node determines that a network to which the first super node belongs does not include the target data.

At step 403, the first super node sends the data request to the content list server.

At step 404, the content list server determines the target edge server corresponding to the target data by querying a first content list.

Here, the first content list includes a mapping relationship between edge servers and contents.

At step 405, the content list server determines a second super node corresponding to the target data by querying a second content list.

Here, the second content list includes a mapping relationship between super nodes and contents.

At step 406, the content list server determines that current time delay and bandwidth of the target edge server are superior to current time delay and bandwidth of the second super node.

At step 407, the content list server directs the data request to the target edge server.

At step 408, the target edge server returns the target data to the first node.

The target edge server is determined by the content list server based on the identification of the target data and the first content list.

By the interaction among the first node, the first super node, the content list server and the target edge server, when the first node requests the target data, a quick acquisition of the target data from the target edge server corresponding to the target data based on the mapping relationship can be realized, thereby reducing the burden on the network, simplifying the process of obtaining the personalized data, saving the acquisition time of the personalized data, and improving the user experience.

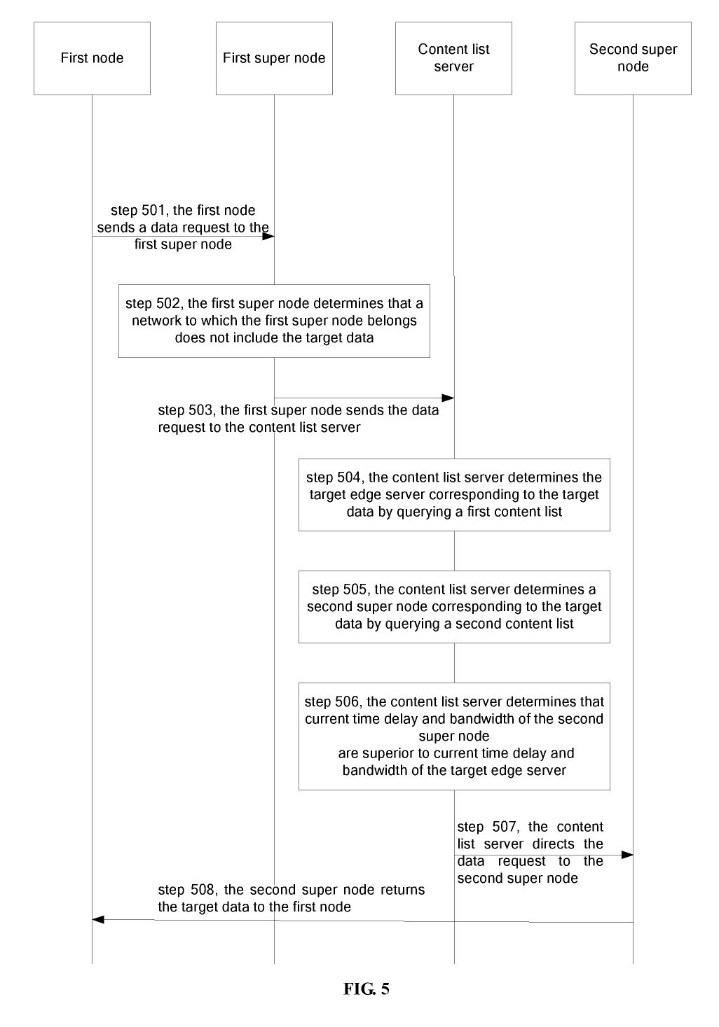

FIG. 5 is another diagram illustrating signaling interaction in a content scheduling method based on CDN and P2P network according to some embodiments of the present disclosure.

As shown in FIG. 5, the content scheduling method based on CDN and P2P network are implemented by a first node, a first super node, a content list server and a second super node, and the signaling interaction includes the following steps of 501 to 508.

At step 501, the first node sends a data request to the first super node. Here, the data request carries an identification of target data and an identification of the first node requesting the target data.

At step 502, the first super node determines that a network to which the first super node belongs does not include the target data.

At step 503, the first super node sends the data request to the content list server.

At step 504, the content list server determines the target edge server corresponding to the target data by querying a first content list.

Here, the first content list includes a mapping relationship between edge servers and contents.

At step 505, the content list server determines a second super node corresponding to the target data by querying a second content list.

Here, the second content list includes a mapping relationship between super nodes and contents.

At step 506, the content list server determines that current time delay and bandwidth of the second super node are superior to current time delay and bandwidth of the target edge server.

At step 507, the content list server directs the data request to the second super node.

At step 508, the second super node returns the target data to the first node.

By the interaction among the first node, the first super node, the content list server and the second super node, when the first node requests the target data, a quick acquisition of the target data from the second super node corresponding to the target data based on the mapping relationship can be realized, thereby reducing the burden on the network, simplifying the process of obtaining the personalized data, saving the acquisition time of the personalized data, and improving the user experience.

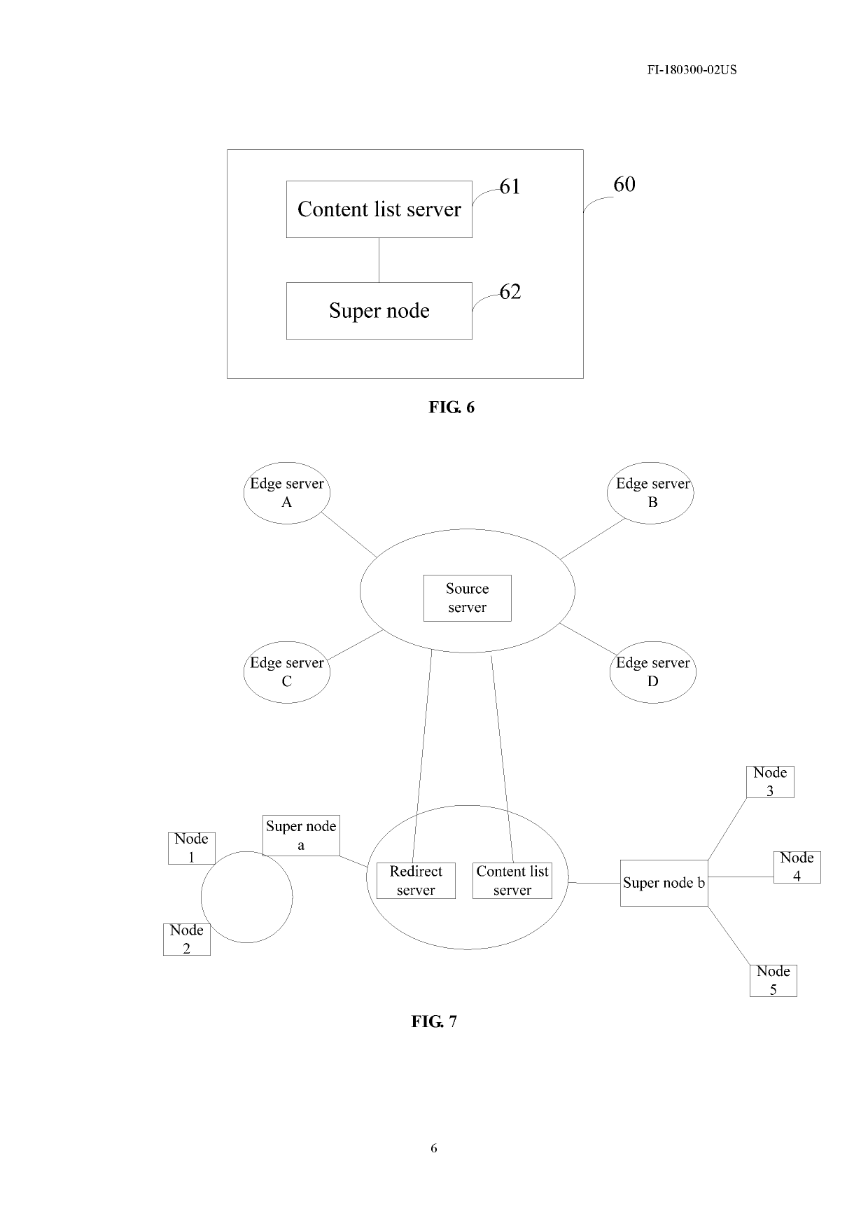

FIG. 6 is a schematic diagram illustrating the structure of a communication network according to some embodiments of the present disclosure.

As shown in FIG. 6, the communication network 60 includes a content list server 61 and a super node 62.

For example, the content list server may be configured to include a memory and one or more processors coupled with the memory, and the memory stores computer executable instructions. For example, the super node may be configured to include a memory and one or more processors coupled with the memory, and the memory stores computer executable instructions.

In some embodiments, when the computer executable instructions stored in the memory of the content list server are executed, the one or more processors of the content list server is caused to perform the content scheduling method based on CDN and P2P network described with respect to the content list server side. In some embodiments, when the computer executable instructions stored in the memory of the super node are executed, the one or more processors of the super node is caused to perform the content scheduling method based on CDN and P2P network described with respect to the super node side.

In the communication network according to the embodiments of the present disclosure, a content list server may be provided in the network, and the content list server is configured to store a mapping relationship between edge servers and their stored contents, such that when a node requests target data through a first super node, the target data can be quickly acquired, based on the mapping relationship, from an edge server corresponding to the target data, thereby reducing the burden on the network, simplifying the process of obtaining the personalized data, saving the acquisition time of the personalized data, and improving the user experience.

FIG. 7 is a schematic diagram illustrating another structure of a communication network according to some embodiments of the present disclosure.

As shown in FIG. 7, the communication network may include super nodes, nodes in networks to which the super nodes belong, a content list server, a redirect server, edge servers, and a source server.

For example, the super nodes and their corresponding nodes constitute regional P2P networks, the source server and its corresponding edge servers constitute a data layer of the CDN network, and the content list server and the redirect server constitute information interacting channels between the regional P2P networks and the data layer of the CDN network.

In FIG. 7, two different network structures of regional P2P networks are illustrated, i.e., the decentralized :P2P network on the left side and the centralized P2P network on the right side. Regardless of types of the P2P networks, the technical solutions of the present disclosure can be implemented therein.

Data may be acquired from the source server by the edge servers and may be cached in the edge servers.

For example, node 1 may send a data request to super node “a”, and if the super node “a” determines that node 2 includes target data, it can send the data request to the node 2, such that the node 2 can send the target data to the node 1.

If the super node “a” determines that the network to which it belong does not include the target data, it can send the data request to the content list server. The data request includes an identification of the target data and an identification of the node 1 requesting the target data.

After the content list server acquires the data request, it may determine a target edge server and a target super node corresponding to the target data by querying a first content list and a second content list. In a case where the target edge server is an edge server A, the target super node is the super node “b”, and current time delay and bandwidth of the edge server A are superior to those of the super node “b”, the content list server may send the data request to the edge server A through the redirect server, such that the edge server A may return the target data to the node 1.

If the content list server determines that the current time delay and bandwidth of the super node “b” are superior to those of the edge server A, the content list server may send the data request to the super node “b” through the redirect server, such that the super node “b” may return the target data to the node 1.

In some embodiments, if the time delay and the bandwidth are contrary to each other (e.g., the time delay of the super node is superior to that of the edge server while the bandwidth of the super node is not superior to that of the edge server), the determination may be performed in such a rule that the priority of the time delay is higher than the priority of the bandwidth.

It should be noted that, in some embodiments, a plurality of cloud storage servers may be respectively provided and distributed in countries, regions, networks and the like. The cloud storage servers may acquire data from the source server and store the acquired data, such that one or more edge servers can directly acquire data from the cloud server, which is located in a same country, region, network, or the like, rather than acquiring data from the source server, and store the acquired data, thereby reducing the burden on the network, simplifying the process of obtaining the personalized data, and improving efficiency of the whole network.

Further, in some embodiments, the structure of the P2P network and its P2P communication manner may be implemented by using Distributed Hash Table (DHT) protocol or Chord protocol. In a case of Chord protocol, the burden of super nodes can be reduced to the largest extent and the robustness of the network can be improved. In the case of Chord protocol, a key word (Key) may be mapped into a random node, and a ID may be generated for each node and key word by consistent Hashing, such that a ring topology may be constructed in accordance with the order of Ms, and the operation of the P2P network can be maintained based on Finger tables of routers in the super nodes.

It should be noted that the structural illustration of the communication network in FIG. 7 is only an exemplary explanation, and should not be construed as limitations on the solutions of the present application.

In the communication network according to the embodiments of the present disclosure, a content list server may be provided in the network, and the content list server is configured to store a mapping relationship between edge servers and their stored contents, such that when a node requests target data through a first super node, the target data can be quickly acquired, based on the mapping relationship, from an edge server corresponding to the target data, thereby reducing the burden on the network, simplifying the process of obtaining the personalized data, saving the acquisition time of the personalized data, and improving the user experience.

Embodiments of the present disclosure further provide a non-transitory computer readable storage medium, and when instructions stored in the storage medium are executed by a processor(s), the processor(s) is caused to perform a content scheduling method based on CDN and P2P network, the method including steps of: acquiring, by a content list server, a data request sent from a first super node, the data request carrying an identification of target data and an identification of a first node requesting the target data; determining, by the content list server, a target edge server corresponding to the target data by querying a first content list, the first content list including a mapping relationship between edge servers and contents; and directing the data request to the target edge server, such that the target edge server sends the target data to the first node.

Embodiments of the present disclosure further provide a non-transitory computer readable storage medium, and when instructions stored in the storage medium are executed by a processor(s), the processor(s) is caused to perform a content scheduling method based on CDN and P2P network, the method including steps of: acquiring, by a first super node, a data request sent from a first node, the data request carrying an identification of target data; sending, by the first super node, the data request to a content list server, when it is determined that a network to which the first super node belongs does not include the target data; and receiving the target data returned from a target edge server, the target edge server being determined by the content list server based on the identification of the target data and a first content list.

Embodiments of the present disclosure further provide a computer program product, and when instructions in the computer program product are executed by a processor(s), the processor(s) is caused to perform a content scheduling method based on CDN and P2P network, the method including steps of: acquiring, by a content list server, a data request sent from a first super node, the data request carrying an identification of target data and an identification of a first node requesting the target data; determining, by the content list server, a target edge server corresponding to the target data by querying a first content list, the first content list including a mapping relationship between edge servers and contents; and directing the data request to the target edge server, such that the target edge server sends the target data to the first node.

Embodiments of the present disclosure further provide a computer program product, and when instructions in the computer program product are executed by a processor(s), the processor(s) is caused to perform a content scheduling method based on CDN and P2P network, the method including steps of: acquiring, by a first super node, a data request sent from a first node, the data request carrying an identification of target data; sending, by the first super node, the data request to a content list server, when it is determined that a network to which the first super node belongs does not include the target data; and receiving the target data returned from a target edge server, the target edge server being determined by the content list server based on the identification of the target data and a first content list.

Embodiments of the present disclosure farther provide a computing device including a memory and one or more processors coupled with the memory, the memory stores computer executable instructions, which when executed, cause the one or more processors to perform a content scheduling method based on CDN and P2P network, the method including steps of: acquiring, by a content list server, a data request sent from a first super node, the data request carrying an identification of target data and an identification of a first node requesting the target data; determining, by the content list server, a target edge server corresponding to the target data by querying a first content list, the first content list including a mapping relationship between edge servers and contents; and directing the data request to the target edge server, such that the target edge server sends the target data to the first node.

Embodiments of the present disclosure further provide a computing device including a memory and one or more processors coupled with the memory, the memory stores computer executable instructions, which when executed, cause the one or more processors to perform a content scheduling method based on CDN and P2P network, the method including steps of: acquiring, by a first super node, a data request sent from a first node, the data request carrying an identification of target data; sending, by the first super node, the data request to a content list server, when it is determined that a network to which the first super node belongs does not include the target data; and receiving the target data returned from a target edge server, the target edge server being determined by the content list server based on the identification of the target data and a first content list.

In the description of the present specification, the description referring to the terms “one embodiment”, “some embodiments”, “an example”, “a specific example”, “some examples” or the like means specific features, structures, materials, or features described in conjunction with the embodiment or example are included in at least one embodiment or example of the present disclosure. In this specification, the schematic representation of the above terms does not necessarily have to refer to the same embodiment or example. Furthermore, the particular features, structures, materials, or characteristics described may be combined in any suitable manner in any one or more of the embodiments or examples. In addition, those skilled in the art may combine and incorporate different embodiments or examples and features thereof described in this specification without conflicting with each other.

Furthermore, the terms “first” and “second” are used for descriptive purposes only, and are not to be construed as indicating or implying relative importance or implicitly indicating the number of indicated technical features. Thus, features defined as “first”, “second” may explicitly or implicitly include at least one such feature. In the description of the present disclosure, the meaning of “plurality” is at least two, such as two, three, etc., unless specifically defined otherwise.

Any process or method described in the flowcharts or otherwise described herein may be read to mean modules, sections, or portions of code that represent executable instructions that include one or more steps for implementing a custom logic function or process, and the scope of the preferred embodiment of the present disclosure includes additional implementations in which functions may be performed in a sequence that is not shown or discussed, including in a substantially simultaneous manner or in reverse order depending on the function involved, which will be understood by those skilled in the art to which the embodiments of the present disclosure pertain.

The logic and/or steps represented in the flowchart or otherwise described herein, for example, may be considered as a sequence listing of executable instructions for implementing logical functions, and may be embodied in any computer-readable medium, for use by, or in conjunction with, an instruction execution system, device, or apparatus (e.g., a computer-based system, a system including a processor, or other system that can fetch instructions from, and execute instructions from, an instruction execution system, device, or apparatus). For the purposes of this specification, a “computer-readable medium” can be any means that can contain, store, communicate, propagate, or transport the program for use by or in conjunction with the instruction execution system, device, or apparatus. More specific examples (non-exhaustive listings) of a computer-readable medium include the following: an electrical connection (electronic device) having one or more wires, a portable computer disk cartridge (magnetic device), random access memory (RAM), Read-only memory (ROM), erasable editable read-only memory (EPROM or flash memory), fiber optic devices, and portable compact disk read-only memory (CDROM). In addition, the computer-readable medium may even be paper or other suitable medium on which the program may be printed, as it may be scanned optically, for example, on paper or other media, followed by editing, interpretation, or other suitable processing manner if necessary, to obtain the program electronically and then store the program in computer memory.

Portions of the present disclosure may be implemented in hardware, software, firmware, or a combination thereof. In the above embodiments, a plurality of steps or methods may be implemented using software or firmware stored in a memory and executed by a suitable instruction execution system. For example, if implemented in hardware, as in another embodiment, it can be implemented using any one or a combination of the following techniques known in the art: discrete logic circuit having logic gate circuits for implementing logic functions on data signals, Central Processing Units (CPUs), Digital Processors (DSPs), Application Specific Integrated Circuits (ASICs), Programmable Gate Arrays (PGAs), Field Programmable Gate Arrays (FPGAs), etc. with suitable combinational logic gate circuits.

The structure of the network described in the present disclosure can be connected between the content distribution network (CDN) and the peer-to-peer (P2P) network, between the servers of the content distribution network (CDN), and between the nodes of the peer-to-peer (P2P) network through various communication connections, for example, wireless network, wired network, and/or any combination of wireless network and wired network. The network may include a local area network, the Internet, a telecommunications network, the Internet of Things based on the Internet and/or a telecommunications network, and/or any combination of the above networks, and the like. The wired network may use, for example, twisted pair, coaxial cable, or optical fiber transmission for communication. The wireless network may use, for example, a 3G/4G/5G mobile communication network, Bluetooth, Zigbee, or Wi-Fi.

Persons of ordinary skill in the art may understand that all or part of steps carried in the method of implementing the foregoing embodiments may be instructed by a program to instruct the relevant hardware, and the program may be stored in a computer-readable storage medium. When executed, the program includes one or a combination of the steps of the method embodiments.

In addition, each functional unit in each embodiment of the present disclosure may be integrated in one processing module, or each unit may exist alone physically, or two or more units may be integrated in one module. The above integrated module can be implemented in the form of hardware or in the form of a software function module. The integrated module can also be stored in a computer readable storage medium if it is implemented in the form of a software functional module and sold or used as an independent product.

The above-mentioned storage medium may be a read-only memory, a magnetic disk, an optical disk, or the like. Although embodiments of the present disclosure have been shown and described above, it will be understood that the above embodiments are exemplary and not to be construed as limiting the present disclosure, and that those of ordinary skill in the art may make variations, modifications, substitutions and changes to the above embodiments within the scope of the present disclosure.

What is claimed is:

1. A content scheduling method based on content delivery network (CDN) and peer-to-peer (P2P) network, comprising steps of:
acquiring, by a content list server, a data request sent from a first super node, the data request carrying an identification of target data and an identification of a first node requesting the target data;
determining, by the content list server, a target edge server corresponding to the target data by querying a first content list stored in the content list server, the first content list comprising a mapping relationship between edge servers and contents; and
directing the data request to the target edge server, such that the target edge server sends the target data to the first node.

2. The method of claim 1, wherein the content list server further stores a second content list comprising a mapping relationship between super nodes and contents, and after the step of acquiring the data request sent from the first super node, the method further comprises a step of determining, by the content list server, a target super node corresponding to the target data by querying the second content list.

3. The method of claim 2, before the step of directing the data request to the target edge server, further comprising steps of:
determining whether current time delay and bandwidth of the target edge server are superior to current time delay and bandwidth of the target super node,
in response to the current time delay and bandwidth of the target edge server being superior to the current time delay and bandwidth of the target super node, directing the data request to the target edge server, such that the target edge server sends the target data to the first node, and
in response to the current time delay and bandwidth of the target edge server not being superior to the current time delay and bandwidth of the target super node, directing the data request to the target super node, such that the target super node sends the target data to the first node.

4. The method of claim 1, further comprising a step of sending, by the content list server at a selected time interval, a first content list acquisition request to the edge servers.

5. The method of claim 1, further comprising a step of updating, by the content list server, the first content list based on a data update message acquired from a back-to-source-authentication server.

6. The method of claim 1, wherein the step of directing the data request to the target edge server comprises sending the data request and an identification of the target edge server to a redirect server, such that the data request is sent from the redirect server to the target edge server.

7. The method of claim 2, further comprising a step of updating, by the content list server, content in the second content list corresponding to the first super node based on the identification of the target data.

8. The method of claim 1, wherein the content list server further comprises a third content list comprising a mapping relationship between warm-up edge servers and contents; and
after the step of acquiring the data request sent from the first super node, the method further comprises steps of:
determining whether the identification of the target data satisfies a selected criterion; and
in response to the identification of the target data satisfying the selected criterion, querying the third content list by the content list server to determine a warm-up edge server corresponding to the identification of the target data.

9. The method of claim 2, wherein the content list server further comprises a third content list comprising a mapping relationship between warm-up edge servers and contents; and
after the step of acquiring the data request sent from the first super node, the method further comprises steps of:
determining whether the identification of the target data satisfies a selected criterion; and
in response to the identification of the target data satisfying the selected criterion, querying the third content list by the content list server to determine a warm-up edge server corresponding to the identification of the target data.

10. A content scheduling method based on content delivery network (CDN) and peer-to-peer (P2P) network, comprising steps of:
acquiring, by a first super node, a data request sent from a first node, the data request carrying an identification of target data;
sending, by the first super node, the data request to a content list server, when it is determined that a network to which the first super node belongs does not comprise the target data; and
receiving the target data returned from a target edge server, the target edge server being determined by the content list server based on the identification of the target data and a first content list, the first content list comprising a mapping relationship between edge servers and contents.

11. The method of claim 10, further comprising a step of receiving the target data returned from a second super node, the second super node being determined by the content list server after the content list server determines that current time delay and bandwidth of the second super node are superior to current time delay and bandwidth of the target edge server.

12. The method of claim 10, further comprising a step of updating a content list corresponding to the first node after the first super node determines that the first node has acquired the target data.

13. A communication network, comprising a content list server and a super node,
wherein the content list server comprises a memory and one or more processors coupled with the memory, the memory stores a first content list and computer executable instructions, which when executed, cause the one or more processors of the content list server to perform operations of
acquiring a data request sent from the super node, the data request carrying an identification of target data and an identification of a first node requesting the target data;
determining a target edge server corresponding to the target data by querying the first content list, the first content list comprising a mapping relationship between edge servers and contents; and
directing the data request to the target edge server, such that the target edge server sends the target data to the first node;
and wherein the super node comprises a memory and one or more processors coupled with the memory the memory stores computer executable instructions, which when executed, cause the one or more processors of the super node to perform operations of:
acquiring the data request sent from the first node;
sending the data request to the content list server, when it is determined that a network to which the super node belongs does riot comprise the target data; and
receiving the target data returned from the target edge server.

14. The communication network of claim 13, wherein the memory of the content list server further stores a second content list, comprising a mapping relationship between super nodes and contents, and computer executable instructions, which when executed, cause the one or more processors of the content list server to perform an operation of: determining a target super node corresponding to the target data by querying the second content list.

15. The communication network of claim 14, wherein the memory of the content list server further stores computer executable instructions, which when executed, cause the one or more processors of the content list server to perform an operation of sending a first content list acquisition request to the edge servers at a selected time interval.

16. The communication network of claim 13, wherein the memory of the content list server further stores computer executable instructions, which when executed, cause the one or more processors of the content list server to perform an operation of updating the first content list based on a data update message acquired from a back-to-source-authentication server.

17. The communication network of claim 13, wherein the memory of the content list server further stores computer executable instructions, which when executed, cause the one or more processors of the content list server to perform an operation of sending the data request and an identification of the target edge server to a redirect server, such that the data request is sent from the redirect server to the target edge server.

18. The communication network of claim 14, wherein the memory of the content list server further stores computer executable instructions, which when executed, cause the one or more processors of the content list server to perform an operation of updating content in the second content list corresponding to the super node based on the identification of the target data.

19. A computing device, comprising a memory and one or more processors coupled with the memory, wherein the memory stores computer executable instructions, which when executed, cause the one or more processors to perform one or more steps of the method according to claim 1.

20. A computing device, comprising a memory and one or more processors coupled with the memory, wherein the memory stores computer executable instructions, which when executed, cause the one or more processors to perform one or more steps of the method according to claim 10.
